(19) United States
(12) Patent Application Publication
(10) Pub. No.: US 2020/0383866 A1
(43) Pub. Date: Dec. 10, 2020

(54) Therapeutic Roller Bracing System

(71) Applicants: Alan Scott Crarer, Santa Cruz, CA (US); Marcus McDonough, Santa Cruz, CA (US)

(72) Inventors: Alan Scott Crarer, Santa Cruz, CA (US); Marcus McDonough, Santa Cruz, CA (US)

(21) Appl. No.: 16/894,381

(22) Filed: Jun. 5, 2020

Related U.S. Application Data
(60) Provisional application No. 62/857,818, filed on Jun. 6, 2019.

(51) Int. Cl. A61H 15/00

(52) U.S. Cl. CPC A61H 15/00; A61H 2015/0007; A61H 2201/0192; A61H 2201/0119; A61H 2201/1657

(57) ABSTRACT

An apparatus that enables most common rollers to be utilized to apply shear force to a user by placing a roller into a pair of braces which each include a base support structure which is configured to receive a roller, wherein each base support structure has a rotation prevention mechanism which may be utilized to brace the roller, so that when a user applies a lateral force to the roller, the roller does not noticeably rotate. Each brace prevents rotation in one direction, so when each brace is oriented in a different direction, the roller is thereby prevented from rotating in either direction.

### CROSS-REFERENCE TO RELATED APPLICATIONS

The present application claims the benefit of U.S. Provisional Application No. 62/857,818 filed on Jun. 6, 2019, incorporated by reference herein and for which benefit of the priority date is hereby claimed.

### FEDERALLY SPONSORED RESEARCH

Not applicable.

### SEQUENCE LISTING OR PROGRAM

Not applicable.

### FIELD OF INVENTION

The present invention relates to a roller support, and more particularly, to a stationary roller bracing system.

### FIELD OF INVENTION

The present invention relates to a roller support, and more particularly, to a stationary roller dock system.

### BACKGROUND OF THE INVENTION

Rollers are important tools for athletes, fitness enthusiasts and professionals used by millions of people, and is a multimillion-dollar industry in the health, wellness and fitness world. Rollers are also known as foam rollers, therapeutic rollers, muscle rollers and massage rollers. Rollers aid users in increasing flexibility, reducing soreness and pain, and helping to eliminate muscle knots.

However, a roller (on its own) doesn't address the research related to fascia, its properties and the importance of how it responds to movement (or non-movement). For example, research from The Fascia Research Society found that the most common forms of pain and movement restriction are adhesions in and between the fascial layers.

Regular foam rolling compresses muscle & tissue. Point pressure like this does not create the shear force necessary to break up the adhesions in and between fascial planes. This is the chief element that ‘rolling’ misses. “In order to create shear force the roller must be stationary as the body moves on it to get this essential shearing effect” (2015, Myers). This is very important because “Fascial release is the most direct way to stretch chronically injured tissue, scar tissue, or old injuries that do not resolve” (2012, Wolfe-Dixon).

However, preventing the rotation of a roller that is under shear loading is difficult to do. Mechanical clamping pressure, from rigid elements, is insufficient. Such products or concepts have certain characteristics that are believed by the inventors to be in need of improvement.

### SUMMARY OF THE INVENTION

In accordance with the present invention, there is provided an apparatus that enables shear force by bracing a common roller into place; transforming it into a highly effective tool for pain relief, scar tissue release and addressing chronic injuries. Simply by placing any sized high/med/soft density or any sized hollow roller into the present invention (referred to as the RollDoc System), pulling the straps tight to keep the roller stationary, the user is able to move their body slowly over the roller—generating shear force into the fascia in any particular body part. Easily loosen the straps and remove the roller from the system to get back to traditional foam rolling as needed. The RollDoc System does not damage, or alter, the roller.

Doctors, Physical Therapists, Chiropractors, Personal Trainers, Instructors, Massage Therapists and Clinical Professionals can augment their treatments with highly effective at home foam rolling usage with the help of the RollDoc System for their clients/patients. It can be used with recovery, pain management, chronic injury and preventative care. The RollDoc System enhances the efficiency and effectiveness of foam rolling by giving users more satisfying relief and longer lasting results.

### BRIEF DESCRIPTION OF THE DRAWINGS

A complete understanding of the present invention may be obtained by reference to the accompanying drawings, when considered in conjunction with the subsequent, detailed description.

FIG. 1—A front oblique view of the RollDoc System comprising RollDoc braces. The view shows the RollDoc System with a roller secured.

FIG. 2—A front oblique view of the RollDoc System comprising two RollDoc braces. The view shows the RollDoc System prior to securing a roller.

FIG. 3—A front view of a base support structure.

FIG. 4—A rear view of a base support structure.

FIG. 5—A rear oblique view of a strap.

FIG. 6—A bottom oblique view of a strap mid handle.

FIG. 7—A front view of a strap channel cover.

FIG. 8—A front oblique view of a retainer.

FIG. 9—A top view of a foot.

FIG. 10—A front oblique exploded view of a RollDoc brace.

FIG. 11—A rear oblique view of a RollDoc brace.

FIG. 12—A front view of a RollDoc brace. This view show the RollDoc System with a form roller secured.

For purposes of clarity and brevity, like elements and components will bear the same designations and numbering throughout the Figures.

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed with the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

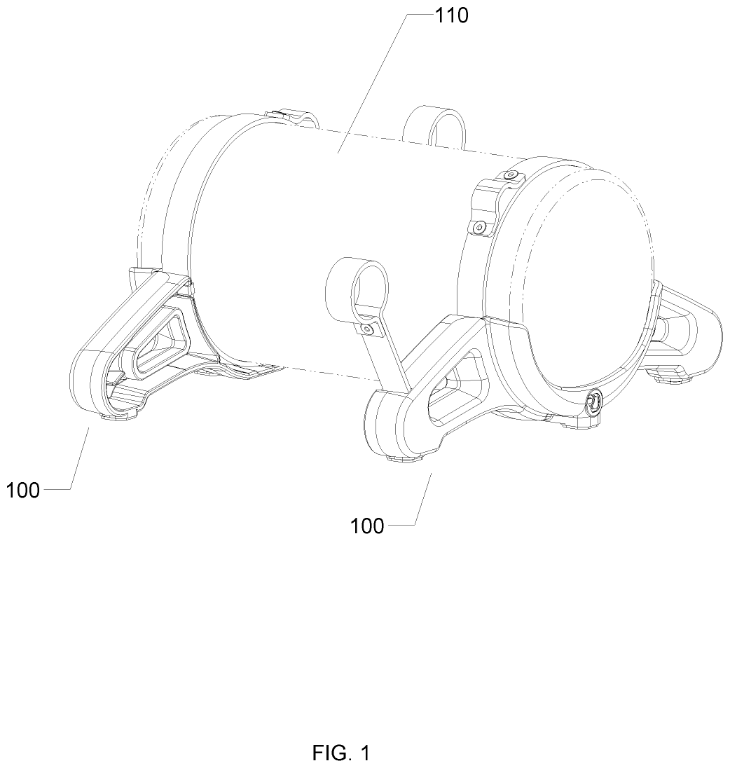

The RollDoc System is shown in FIG. 1, wherein a roller 110 has been secured into the RollDoc System and is ready to be used by a user. The RollDoc System shown comprises two RollDoc braces 100. In one embodiment of the present invention, each of the two RollDoc braces 100 are oriented in an opposite direction. As can be seen, the RollDoc brace 100 at the distal end of the roller 100 is oriented to the front, and the RollDoc brace 100 at the proximal end of the roller 110 is oriented to the rear. This prevents the roller 110 from rotating in either direction. In one embodiment of the present invention, the roller moves slightly so that it locks against a pinch point. The orientations can be changed. For example, the RollDoc brace 100 at the distal end of the roller 110 could be oriented to the rear as long as the RollDoc brace 100 at the proximal end of the roller 110 is oriented to the front. In one embodiment of the present invention, each RollDoc brace 100 prevents rotation in one direction only. By placing two RollDoc braces 100 in an opposing configuration prevents rotation of the roller 110 in both directions.

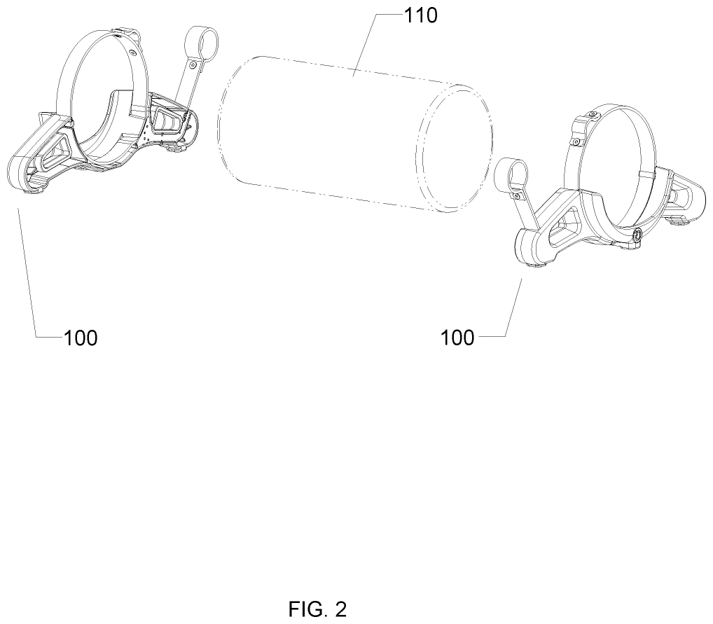

The RollDoc System is shown in FIG. 2, wherein a roller 110 has not yet been secured into the RollDoc System. The RollDoc System shown comprises two RollDoc braces 100 which are configured to receive and secure a roller 110, thereby preventing the roller 110 from rotating around its axis. Prior to receiving the roller 110, the opening provided by the strap of each RollDoc brace 100 is larger than the diameter of the roller 110, allowing the ends of the roller to be inserted into the opening provided by the strap of each RollDoc brace 100, and the roller may be secured by tightening the strap of each RollDoc brace 100. In one embodiment of the present invention, each of the two RollDoc braces 100 are oriented in an opposite direction. As can be seen, the RollDoc brace 100 at the distal end of the roller 100 is oriented to the front, and the RollDoc brace 100 at the proximal end of the roller 110 is oriented to the rear. This prevents the roller 110 from rotating in either direction. In one embodiment of the present invention, when tangential force is applied, the roller 110 moves slightly so that it locks against a pinch point. The orientations can be changed. For example, the RollDoc brace 100 at the distal end of the roller 100 could be oriented to the rear as long as the RollDoc brace 100 at the proximal end of the roller 110 is oriented to the front.

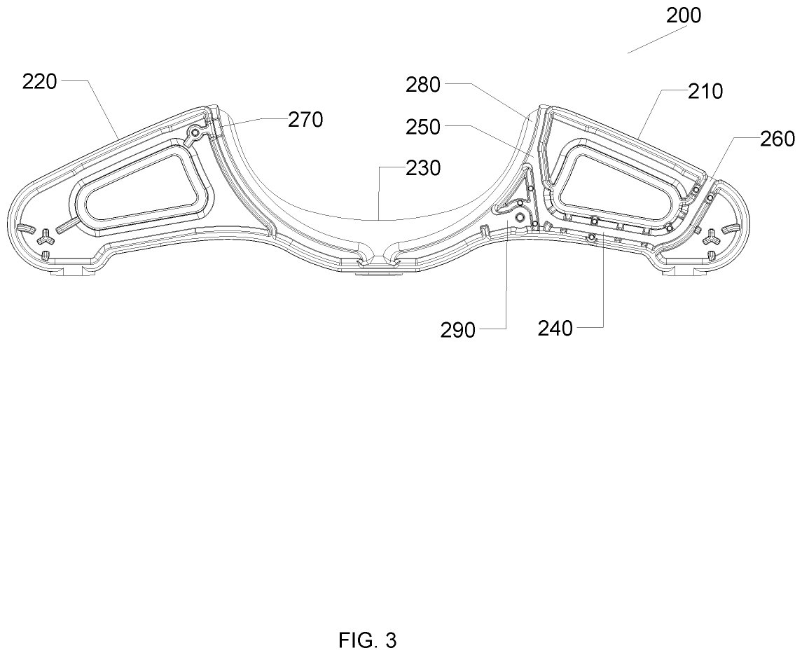

Each RollDoc brace 100 includes a rotation prevention mechanism and a base support structure. In one embodiment of the present invention, the rotation prevention mechanism comprises a strap. Turning now to FIG. 3, shown is a front view of a base support structure 200. For orientation, shown is the proximal buttress 210 and the distal buttress 220 of the base support structure 200, with the cavity 230 between them. The cavity 230 is configured to received a roller. The base support structure 200 is configured with a strap channel 240, which runs from the strap channel ingress 250 to the strap channel egress 260. The base support structure 200 is also configured with a strap end retainer 290. The strap channel 240 is configured to receive a strap such that a distal end of a strap may be detachably connected to the strap end retainer 290, run along the cavity 230 towards the distal buttress 220, through the retainer 270, and around an inserted roller back toward the proximal buttress 210, and threaded through the strap channel ingress 250, along through the strap channel 240, and out through the strap channel egress 260. Once threaded as such, a user can pull the proximal end the strap to secure a roller, which occurs by placing pressure at the pinch point 280. The base support structure 200 is also configured with a retainer 270 which also may be used to secure the strap to the base support structure 200 when not in use. The base support structure 200 is manufactured out of a rigid material. The base support structure comprises two legs or buttresses on either side of a semi-circular cavity configured to receive a roller. In one embodiment of the present invention, the base is manufactured from ABS. In one embodiment of the present invention, the dimensions are 14.1 inches wide, 3.6 inches deep and 3.2 inches high.

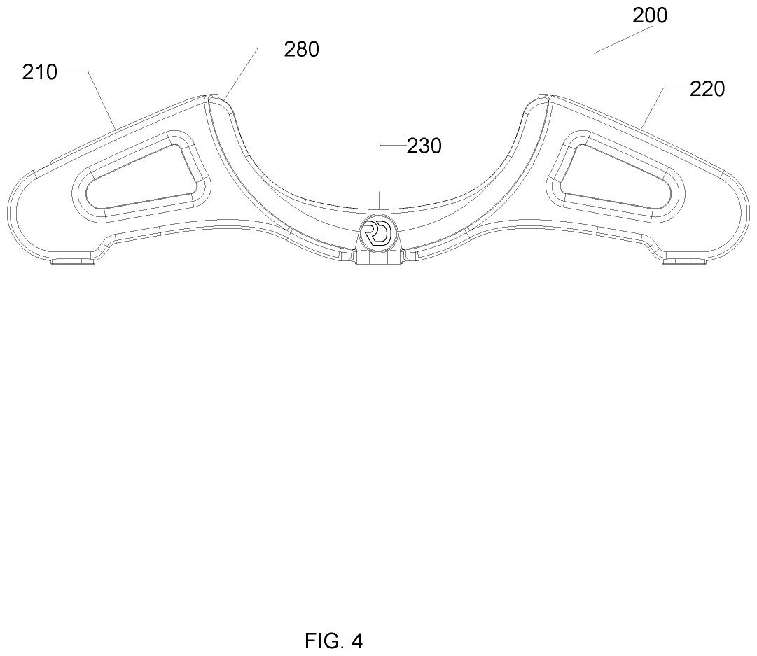

Turning now to FIG. 4, shown is a rear view of a base support structure 200. In one embodiment of the present invention, a strap is secured on the proximal retainer side 210, run along the cavity 230 towards the distal buttress 220 and around an inserted roller back toward the proximal buttress 210, whereby the strap can be tightened. In one embodiment of the present invention, the strap is tightened to hold the roller in place, but is loosely held so the when tangential force is applied to the roller, it moves slightly in order to place pressure at the pinch point 280, which thereby locks the roller in place.

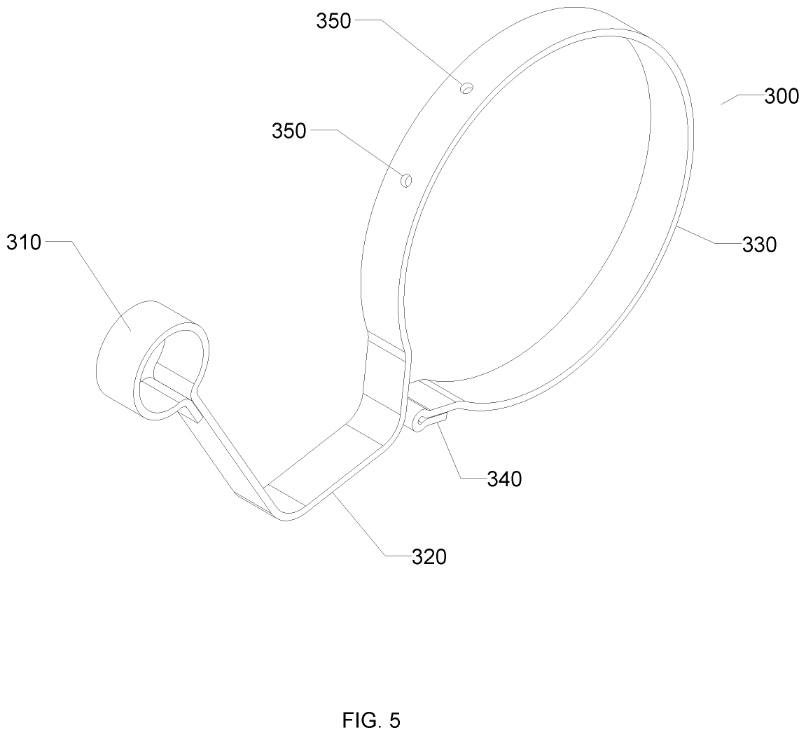

Turning now to FIG. 5, shown is a rear oblique view of a strap 300. The strap end 340 is comprised of the strap folded over into a loop, thereby enabling the strap end 340 to be detachably connected to a strap end retainer 290 (not shown) of a base support structure 200 (not shown). In one embodiment of the present invention, the strap end retainer 290 is a post over which the loop of the strap end 340 slides over, thereby affixing the strap end 340 to the base support structure. The strap roller part 330 is the portion of the strap 300 that wraps around a roller. Strap mid handle holes 350 may be used to facilitate affixing a strap mid handle 360 (not shown) to the strap 300. The strap channel part 320 is the portion of the strap 300 that is threaded through the strap channel 240 of the base support structure 200. The strap handle 310 at the proximal end of the strap 300 is used by the user by pulling on it to tighten the strap 300 around a roller. The strap 300 secures the roller in place, and prevents it from rotating. In one embodiment of the present invention, the strap 300 loosely holds the roller in place, so the when tangential force is applied to the roller, it moves slightly in order to place pressure at the pinch point, which thereby locks the roller in place. Being adjustable, the strap 300 accommodates rollers with wide variations in size and hardness. The strap 300 is manufactured out of a tough but flexible material that will bend, but not stretch, such as used for manufacturing automotive or serpentine belts. In one embodiment of the present invention, the strap 300 is manufactured out of fabric reinforced with neoprene rubber. In one embodiment of the present invention, the strap 300 is manufactured out of ethylene propylene diene monomer (EPDM) rubber. In one embodiment of the present invention, the strap 300 is manufactured from rubber nylon straps in which the surface is textured, such as with small grooves or teeth, which provides sufficient friction to prevent the roller from rotating. In one embodiment of the present invention, the strap is manufactured of conformable fabric or rubber.

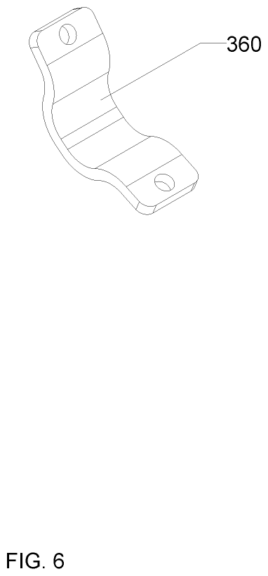

Turning now to FIG. 6, shown is a bottom oblique view of a strap mid handle 360. The strap mid handle 360 is attached to the strap roller part closer to the proximal buttress. The strap mid handle 360 provides leverage so that when pulled away from the roller, the strap sufficiently loosens to more easily enable the removal of the roller.

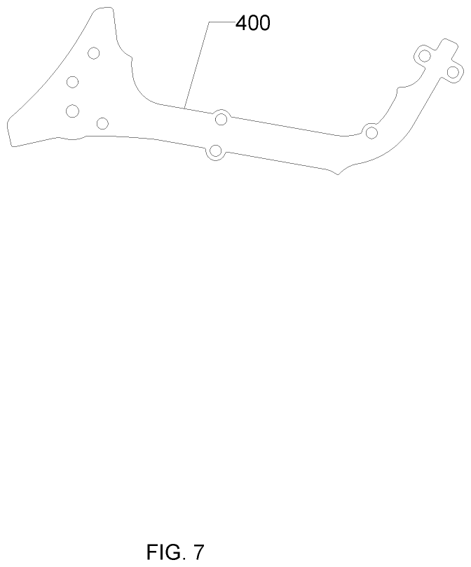

Turning now to FIG. 7, shown is a front view of a strap channel cover 400. In one embodiment of the present invention, the strap channel cover 400 is detachably attached to the front of the proximal buttress 210 of a base support structure 200 (not shown), which prevents the strap 300 (not shown) from dislodging therefrom. The cover is manufactured out of a rigid material. In one embodiment of the present invention, the cover is manufactured from ABS. In one embodiment of the present invention, the dimensions are 4.3 inches wide, 1.6 inches high and ⅛ inch thick.

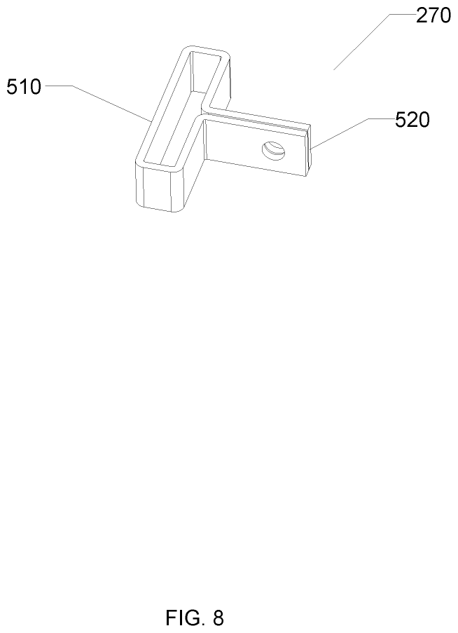

Turning now to FIG. 8, shown is a front oblique view of a retainer 270. The retainer 270 is comprised of a retainer guide 510 and retainer stem 520. In one embodiment of the present invention, the retainer 270 is affixed to the distal buttress 220 of a base support structure 200 (not shown), and a strap 300 (not shown) is threaded through the retainer guide 510 as it wraps around a roller. In one embodiment of the present invention, the retainer 270 is used to reduce the amount of movement of the strap 300 when the RollDoc system is not in use, while allowing necessary movement of the strap 300 when the RollDoc system is in use. The retainer 270 may prevent the strap 300 from unduly flopping about when a roller is not present and to guide it when present. The retainer 270 may be manufactured out of any suitable rigid or semi-rigid material, including metal, plastic, ABS, fabric or a light weight flexible material.

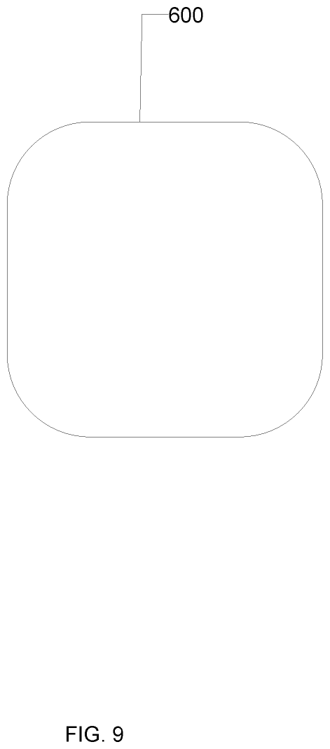

Turning now to FIG. 9, shown is a foot 600, a plurality of which are affixed to the bottom of the base support structures 200 (not shown) in order to provide traction and stability, thereby preventing the base support structure 200 from sliding on the underlying surface. The feet 600 may be manufactured out of any non-slipping material. In one embodiment of the present invention, the feet 600 are adhesive backed rubber. In one embodiment of the present invention, the dimensions of the feet are ¾ inch square by 1/16 inch thick.

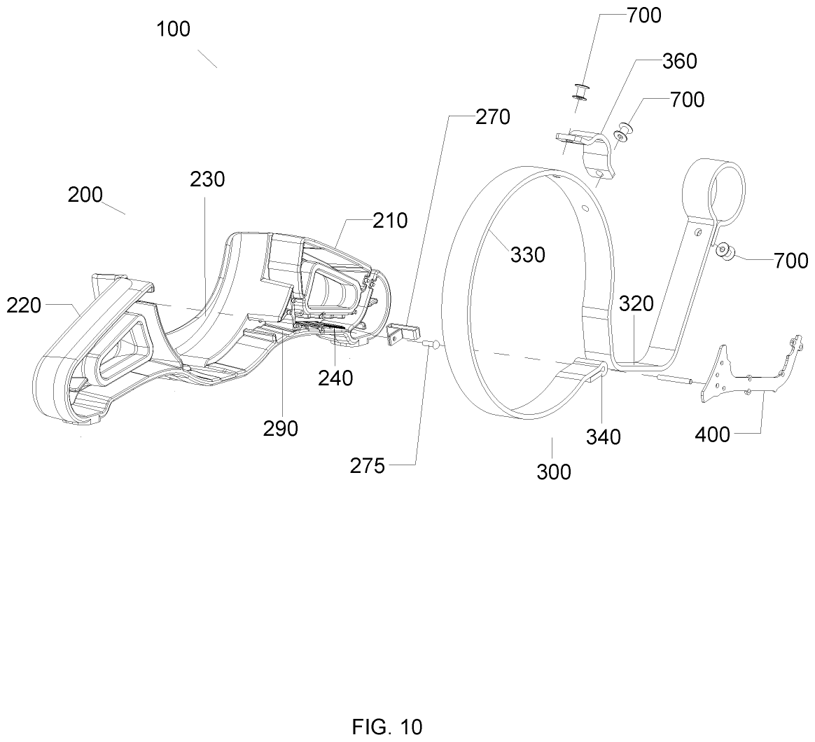

Turning now to FIG. 10, shown is a front oblique exploded view of a RollDoc brace 100. The RollDoc brace 100 comprises a base support structure 200 which comprises a cavity 230 flanked by a proximal buttress 210 and a distal buttress 220. The strap 300 is affixed to the base support structure 200 to brace a roller and prevent it from rotating around its axis. The distal strap end 340 is affixed to the proximal buttress 210 at the strap end retainer 290. In one embodiment of the present invention, the distal strap end 340 comprises a loop in the strap 300 which slides over a post at the strap end retainer 290. After the distal strap end 340 is thereby affixed to the strap end retainer 290, the strap channel cover 400 is affixed to the proximal buttress 210, thereby covering the strap end retainer 290 and preventing the strap 300 from detaching from the proximal buttress 210. The retainer 270 is affixed to the distal buttress 220 with the retainer pin 275 inserted into the retainer stem. The strap roller part 330 of the strap 300 is threaded through the retainer guide of the retainer 270, thereby securing a portion of the strap to the distal buttress 220. The strap mid handle 260 is affixed to the strap roller part 330 of the strap 300 by a pair of fasteners 700. The strap channel part 320 of the strap 300 is threaded through the strap channel 240 of the proximal buttress. After the strap channel part 320 of the strap 300 is thereby threaded through the strap channel 240, the strap channel cover 400 is affixed to the proximal buttress 210, thereby covering the strap channel 240 and preventing the strap 300 from detaching from the proximal buttress 210. In one embodiment of the present invention, the strap handle 310 comprises a loop in the proximal end of the strap 300 secured with a fastener 700.

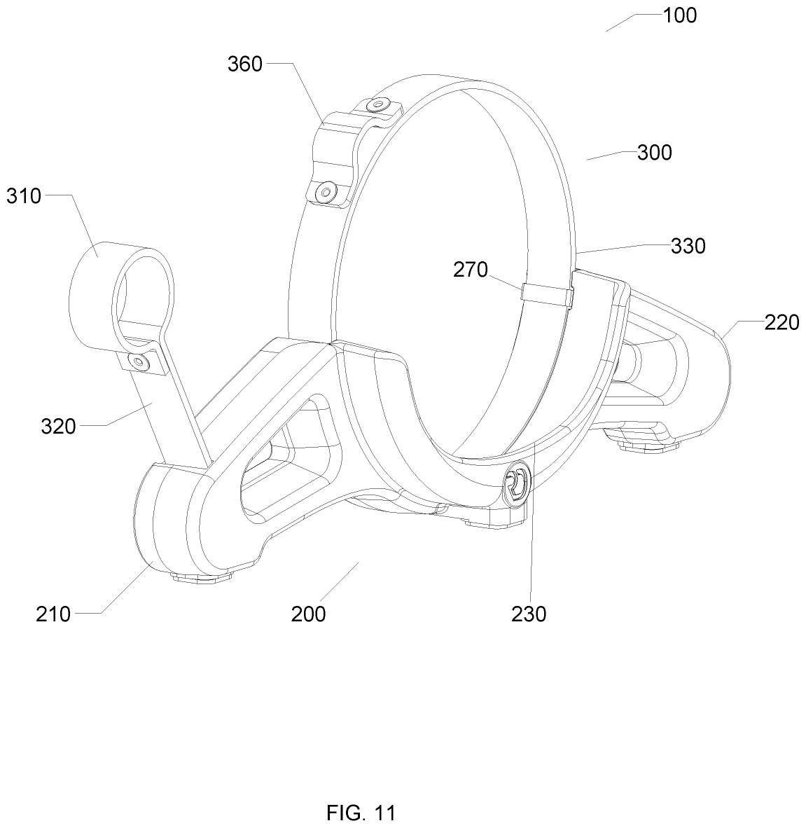

Turning now to FIG. 11, shown is a rear oblique view of a RollDoc brace 100. As can be seen, the strap 300 mounted to the base support structure 200. The strap channel part 320 of the strap 300 extends from the proximal buttress 210, terminating at the strap handle 310. The strap roller part 330 of the strap 300 traverses the cavity 230, is threaded through the retainer 270 affixed to the distal buttress, and loops back to the proximal buttress 210. The strap mid handle 360 is affixed to the strap roller part 330 of the strap 300 on the side closer to the proximal buttress 210 to facilitate loosening the strap 300.

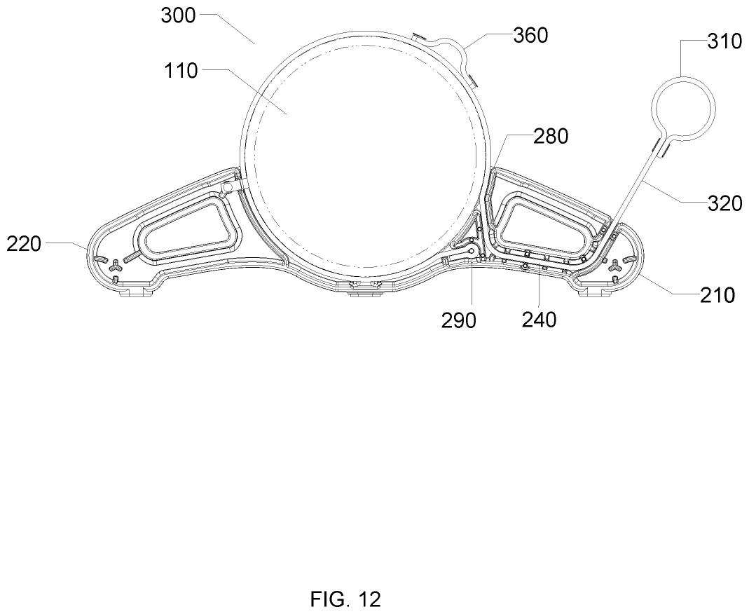

Turning now to FIG. 12, shown is a front view of a RollDoc brace 100. The strap channel cover is not shown, and the strap end retainer 290 is shown with the distal strap end of the strap 300 affixed thereto. The strap 300 traverses the circumference of the roller and enters the strap channel 240 configured in the proximal buttress 210. When the strap handle 310 is pulled, the strap channel part 320 of the strap 300 is pull taught and subsequently restrained from movement due to friction in the strap channel 240. The strap 300 thereby wraps around the roller 110 providing a secure brace. When a tangential force is applied to the roller 110 (in the direction toward proximal buttress), the flexibility of the RollDoc brace allows the roller 110 to move very slightly so that it rises slightly to a pinch point 280, which locks the strap 300 and prevents noticeable rotation of the roller 110. The strap 300 may be loosened by pushing on the strap handle 310 of the strap 300 and pulling on the strap mid handle 360.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. An apparatus for bracing a roller, said apparatus comprising:
two braces, wherein each brace comprises:
a base support structure with a cavity, wherein said cavity is configured to receive said roller,
a rotation prevention mechanism affixed to a proximal side of said base support structure, wherein said rotation prevention mechanism braces said roller in said cavity and prevents said roller from rotating towards said proximal side of said base support structure;
whereby when each of said braces are oriented in an opposite direction to each other, said roller is prevented from rotating in any direction.

2. The apparatus of claim 1, wherein said base support structure further comprises a proximal buttress on a proximal side of said cavity and a distal buttress on a distal side of said cavity.

3. The apparatus of claim 1, wherein said braces are connected on a common platform.

4. The apparatus of claim 2, wherein said rotation prevention mechanism comprises a strap, wherein a distal end of said strap is affixed to said proximal buttress and a proximal end of said strap is slidably attached to said proximal buttress, whereby said strap will brace said roller when said proximal end of said strap is pulled.

5. The apparatus of claim 4, wherein said roller may be unbraced by pushing on said proximal end of said strap.

6. The apparatus of claim 4, wherein said strap further comprises a strap mid handle fixedly attached to said strap, whereby said roller may be unbraced by pulling on said strap mid handle.

7. The apparatus of claim 4, further comprising a retainer affixed to said distal buttress, wherein said strap may be threaded through a retainer guide of said retainer, thereby keeping said strap from flopping or tangling when said roller is not braced.

8. The apparatus of claim 4, further comprising a strap channel part of said strap which is contiguous to said proximal end of said strap, wherein said strap channel part of said strap is threaded through a strap channel configured in said proximal buttress, whereby pulling said proximal end of said strap will brace said roller.

9. The apparatus of claim 4, wherein said roller is prevented from rotating in the direction of said proximal buttress by compressing against a pinch point comprising an apex of the proximal side of said cavity when tangential force is applied to said roller in the direction of said proximal buttress.

10. The apparatus of claim 4, wherein said strap braces said roller, whereby when tangential force is applied to said roller in the direction of said proximal buttress, said roller moves slightly in the direction of said proximal buttress whereby said roller applies force against a pinch point comprising an apex of the proximal side of said cavity, preventing said roller from further movement in the direction of said proximal buttress.

11. The apparatus of claim 4, wherein said strap is manufactured out of conformable fabric, rubber, or nylon rubber straps in which the surface of said rubber nylon straps is textured.

12. An apparatus for bracing a roller, said apparatus comprising:
a base support structure with a cavity, wherein said cavity is configured to receive said roller,
a rotation prevention mechanism affixed to a proximal side of said base support structure, wherein said rotation prevention mechanism braces said roller in said cavity and prevents said roller from rotating towards said proximal side of said base support structure;

13. The apparatus of claim 12, wherein said base support structure further comprises a proximal buttress on a proximal side of said cavity and a distal buttress on a distal side of said cavity.

14. The apparatus of claim 12, wherein said rotation prevention mechanism comprises a strap, wherein a distal end of said strap is affixed to said base support structure and a proximal end of said strap is slidably attached to said base support structure, whereby said strap will brace said roller when said proximal end of said strap is pulled.

15. The apparatus of claim 14, wherein said roller may be unbraced by pushing on said proximal end of said strap.

16. The apparatus of claim 14, wherein said strap further comprises a strap mid handle fixedly attached to said strap, whereby said roller may be unbraced by pulling on said strap mid handle.

17. The apparatus of claim 14, further comprising a retainer affixed to said distal buttress, wherein said strap may be threaded through a retainer guide of said retainer, thereby keeping said strap from flopping or tangling when said roller is not braced.

18. The apparatus of claim 14, further comprising a strap channel part of said strap which is contiguous to said proximal end of said strap, wherein said strap channel part of said strap is threaded through a strap channel configured in said proximal buttress, whereby pulling said proximal end of said strap will brace said roller.

19. The apparatus of claim 14, wherein said roller is prevented from rotating the direction of said proximal buttress by compressing against a pinch point comprising an apex of the proximal side of said cavity when tangential force is applied to said roller in the direction of said proximal buttress.

20. The apparatus of claim 14, wherein said strap braces said roller, whereby when tangential force is applied to said roller in the direction of said proximal buttress, said roller moves slightly in the direction of said proximal buttress whereby said roller applies force against a pinch point comprising an apex of the proximal side of said cavity, preventing said roller from further movement in the direction of said proximal buttress.

21. The apparatus of claim 14, wherein said strap is manufactured out of conformable fabric, rubber, or nylon rubber straps in which the surface of said rubber nylon straps is textured.
